(19) United States
(12) Patent Application Publication
(10) Pub. No.: US 2017/0349001 A1
(43) Pub. Date: Dec. 7, 2017

(54) PROCESS FOR THE PRODUCTION OF A PATTERN HAVING A THREE-DIMENSIONAL APPEARANCE IN A COATING

(71) Applicant: Merck Patent GmbH, Darmstadt (DE)

(72) Inventors: Peter CLAUTER, Pfungstadt (DE); Klaus-Christian ULLMANN, Bensheim (DE); Ruediger SMOLKA, Zwingenberg (DE); Johannes TASCH, Muehlhausen (DE)

(73) Assignee: Merck Patent GmbH, Darmstadt (DE)

(21) Appl. No.: 15/539,190

(22) PCT Filed: Dec. 3, 2015
(86) PCT No.: PCT/EP2015/002541

§ 371 Date: Jun. 23, 2017

(30) Foreign Application Priority Data
Dec. 30, 2014 (EP) 14004450.4

(51) Int. Cl. B44F 7/00; C09D 7/12; C09C 1/00; B44F 1/08; B44F 9/08; C09D 11/037; B32B 3/26; B41M 3/18; B41M 3/14

(52) U.S. Cl. CPC B44F 7/00; C09D 11/037; C09D 7/1291; C09C 1/0015; B32B 3/263; B44F 1/08; B44F 9/08; B41M 3/14; B41M 3/18

(57) ABSTRACT

The present invention relates to a process for the production of a pattern having a three-dimensional appearance in a coating comprising flake-form effect pigments, to a coating produced in this way, and to the use thereof.

The present invention relates to a process for the production of a pattern having a three-dimensional appearance in a coating, in particular for the production of a directly visible pattern having a three-dimensional appearance in a coating comprising flake-form effect pigments on a substrate, to a coating produced by a process of this type, and to the use of a coating of this type, preferably for the production of decorative materials, packaging materials, works of art or security products.

Decorative coatings containing three-dimensional patterns on wallpapers, furniture decoration films or packaging materials are known and are preferably employed for relatively high-value goods or luxurious packaging, since they provide the end products containing them with a particular aura. For this purpose, the corresponding substrates and/or the coatings applied thereto are frequently structured in such a way that they have a tactile, three-dimensional surface structure. This effect is often very desired in order, for example, also to provide, for example, furniture decoration films having a wood grain with a corresponding feel in addition to the wood-like appearance. Structuring of this type is generally carried out via complex embossing processes, which, however, require high equipment complexity and increased production costs. If the three-dimensional patterns desired are also intended to have special effects, such as metallic effects or pearlescence, coating and embossing methods which can also be employed without loss of quality in the case of coatings which comprise corresponding effect pigments or consist of vapour-deposited effect layers are additionally necessary.

In particular for decorative packaging materials, however, a process has been known for some time from WO 2012/079674 in which three-dimensional patterns are generated in coatings which comprise flake-form effect pigments by applying a flowable coating composition, which may comprise flake-form effect pigments, to a substrate and bringing it in the still unsolidified state into contact with a printing plate for letterpress printing, for example a flexographic printing plate, in such a way that the letterpress printing plate generates extremely slight recesses in the micron region in the still unsolidified coating composition, where the coating treated in this way is subsequently subjected to an immediate solidification process. The coatings obtained by the said process have a visible three-dimensional effect of high brightness and depth, since the slight spatial deorientation of the effect pigments results in a very readily perceptible three-dimensional effect in the coating. However, the process requires the transport of a still unhardened coating within a printing line from one coating machine into another, where the coated substrate may be set in vibrating over relatively long distances and guidance of the freshly coated substrate over deflection rolls is impossible. It would therefore be very advantageous for certain areas of application to be able to obtain similarly impressive three-dimensional effects on substrates in which prefabricated, patterned substrates can be transported over longer distances, stored in wound form and provided with a three-dimensional effect coating at any desired point in time.

The prior art also discloses other structuring processes by means of which substrates can be provided with three-dimensional patterns. Thus, for example, EP 0 115 038 discloses a process for the production of coloured decorative paper films in which the films are provided with a three-dimensional surface structure by providing a first print layer, which comprises a release agent and has a pattern, with an overvarnish. The release agent results in thickness differences in the overvarnish, which ultimately generate a perceptible three-dimensional pattern.

U.S. Pat. No. 3,811,915 also discloses a printing process in which a three-dimensional wood pattern is generated by printing, as pattern layer, a printing ink which, besides conventional coloured pigments and the printing ink vehicle, comprises a silicone release compound, onto a primer layer. The top layer applied thereto not only has a visible three-dimensional pattern having a wood structure, due to the release action of the silicone-containing layer, but also has a tactile three-dimensional deformation of the surface of the coating.

U.S. Pat. No. 6,150,009 describes a decorative article which has a pattern of a release material which consists of wax, oil or silicone on a substrate, where the areas of the substrate which are not coated with the release material are coated with a coloured resin which has a greater surface tension than the release material. Since the release material repels the subsequent resin coating in such a way that the resin layer does not adhere to the points of the substrate that are coated with the release agent, varnish surfaces having different thickness and thus a tactile three-dimensional structure are obtained. The resin layer may comprise flake-form effect pigments.

The object of the present invention is to provide a process for the production of a pattern having a three-dimensional appearance in a coating comprising effect pigments on a substrate by means of which readily visible patterns having a three-dimensional appearance can be generated in a coating, the pattern being visible directly and without aids, where the coating has a smooth, un-embossed surface and the optical effects of the effect pigments employed are evident in the coating, an attractive pattern having a three-dimensional depth-like appearance is also obtainable in the case of a very low layer thickness of the coating, and the process can also be carried out simply and in mass production using conventional coating methods in a plurality of separate steps.

A further object of the present invention consists in providing a coating on an unembossed substrate, where the coating has a smooth, unembossed outer surface and a pattern having a three-dimensional appearance which is formed by flake-form effect pigments.

An additional object of the present invention consists in indicating a use for coatings produced in this way.

The object of the present invention is achieved by a process for the production of a pattern having a three-dimensional appearance in a coating comprising effect pigments on a substrate, where a surface of a substrate which is provided in part-regions with area elements which represent a two-dimensional pattern is coated with a coating composition comprising flake-form effect pigments and this coating composition is solidified, where the part-regions of the substrate which are provided with the area elements and part-regions of the substrate which are not provided with the area elements have surface tensions σ1 and σ2 which are different from one another, and where the coating composition comprising flake-form effect pigments has a surface tension σ3 which is lower than the surface tensions σ1 and σ2.

The object of the present invention is in addition achieved by a coating comprising flake-form effect pigments on a substrate, which coating has a visible pattern having a three-dimensional appearance and has been produced by the process described above.

The object of the invention is furthermore also achieved by the use of a coating of this type in decorative materials, packaging materials, works of art and security products.

In the process in accordance with the present invention, a substrate is employed whose surface (at least one surface of a two-dimensional substrate) is provided in part-regions with area elements which represent a two-dimensional pattern.

A substrate pretreated in this way can be produced immediately before the process according to the invention is carried out, but may also be prefabricated in advance. Since the substrate employed and the area elements applied thereto is (are) solid and dry, a substrate prefabricated in this way can if necessary be stored and transported in roll form without the fear of damage to the area elements applied.

The two-dimensional pattern formed by the area elements already represents per se the two-dimensional base pattern for the pattern which is to be present in three-dimensional form after the process according to the invention has been carried out.

The area elements are generated by the application and solidification of a flowable first coating composition to the substrate. This coating composition comprises at least one binder, which cures and/or dries by various methods after application to the substrate, but may also comprise solvents and various assistants and/or additives.

This coating composition can be applied using any conventional coating process, but is, in particular, applied by means of a conventional printing process in order thus to facilitate the production of mass-produced products.

Suitable additives, besides the assistants usually employed in coating compositions, such as, for example, carbon black, fillers, UV stabilisers, inhibitors, flameproofing agents, lubricants, dispersants, redispersants, antifoams, flow-control agents, film formers, adhesion promoters, drying accelerators, drying retardants, photoinitiators, etc., are also, in particular, colouring pigments or dyes. Pigments which can be employed are organic or inorganic absorption pigments and/or effect pigments, in particular flake-form effect pigments. Organic and inorganic absorption pigments are, like dyes, commercially available in a wide variety of grades. Since the use of such coloured pigments and dyes is not particularly limited in accordance with the invention, so long as the surface tension of the solidified first coating composition meets the requirements according to the invention, it is not intended to discuss this further here. Suitable flake-form effect pigments are described below.

In accordance with the invention, the use of primer compositions usually used, which are usually employed for the pre-treatment of substrates, such as paper, cardboard, wallpapers, etc., is preferred for the application of the area elements to the substrate. These primer compositions are commercially available from various suppliers and usually comprise at least one binder and frequently also a solvent, which may be water or also an organic solvent or solvent mixture.

Suitable binders are conventional binders or binder systems which are usually employed in coating processes of a wide variety of types, for example water-based or solvent-containing binders based on nitrocellulose, based on polyamide, based on acrylate, based on polyvinylbutyral, based on PVC, based on PUR or suitable mixtures thereof, so long as the area elements produced therewith meet the conditions according to the invention with respect to the surface tension, which can readily be determined by simple preliminary experiments. Water-based binder systems based on acrylate, as marketed, for example, by Schmid Rhyner AG, Switzerland, under the name GALACRYL® have proven particularly suitable.

Besides water, it is also possible to employ organic solvents in the first coating composition for the application of the area elements, for example branched or unbranched alcohols, aromatic solvents or alkyl esters, such as ethanol, 1-methoxypropanol, 1-ethoxy-2-propanol, ethyl acetate, butal acetate, toluene or mixtures comprising these. Water is preferably employed. However, the first coating composition may also have a low solvent content or be entirely free from solvents.

In a first embodiment according to the invention, the first coating composition comprises no pigments, particular no colouring pigments.

In a second embodiment of the present invention, the first coating composition comprises dyes, absorption pigments and/or effect pigments which have a colouring action and thus determine the optically perceptible colour impression of the area elements on the substrate, since in general colourless and transparent binder systems are employed in the solidified state.

Whereas the area elements on the substrate in accordance with the first embodiment are colourless or in the best case are perceived as a whitish coating on the substrate, the area elements of the second embodiment have a visible colour, which is determined by the dyes and/or pigments employed and their interactions with one another.

None of the said embodiments are particularly preferred In accordance with the invention. Instead, whether the first or second embodiment of the present invention is used for the application of the area elements to the substrate is dependent on the desired colour of the pattern having a three-dimensional appearance.

The substrate employed is conventional two-dimensional substrates which can be coated using conventional coating methods, for example paper of a very wide variety of qualities, cardboard, wallpapers, laminates, tissue materials, wood, plastic bodies, plastic films, metal bodies, metal foils, glass or materials which comprise constituents from a plurality of these substances. The substrates may optionally be pretreated electrostatically or by application of primer or satinisation layers.

Conventional primer or satinisation layers often have a pale or white colour. Substrates precoated in this way are suitable per se as substrates for use in the process according to invention, but the effects having a three-dimensional appearance which can be achieved therewith in the coating are subtle and are not very clearly perceptible.

The substrates therefore preferably have a black, dark or coloured surface. This colouring of the substrate can be obtained, depending on the substrate material employed and intended application of the finished product, either by mass colouring of the substrate material, for example in case of plastic films, or by means of coating of the substrate with a black, dark-coloured coating. The latter can be applied in addition or as an alternative to primer or satinisation layers. A dark coating is taken to mean, for example, grey, brown, blue, red, violet or green coatings which only have low brightness, i.e. are generally referred to as dark grey, dark brown, dark blue, dark red, dark violet or dark green. They can be obtained, in exactly the same way as coloured coatings, by the addition of conventional colourants to corresponding coating compositions, optionally in combination with carbon black or other black colourants. The entire substrate surface to be coated is preferably provided with a black, dark or, alternatively, coloured coating of this type.

In a step prior to the process according to invention, part-regions of a surface of a substrate described above are coated with area elements by the application of a first coating composition, which is preferably a primer composition, and the coating is solidified. These area elements form a two-dimensional pattern on the substrate. Each of the area elements may already per se represent a pattern and/or the totality or parts of the area elements may represent a pattern with one another. The type of pattern is unimportant, for example it can be an abstract pattern, a random pattern, a dot or line pattern, an alphanumeric pattern, a pattern comprising specific objects or a combination of two or more thereof.

It is important in accordance with the invention that the area elements which represent a two-dimensional pattern are only located on part-regions of the substrate and that, in addition, further part-regions of the substrate which are not coated with the area elements are present, where part-regions which are coated with area elements and part-regions which are not coated with area elements are adjacent to one another, so that boundary lines form between the two types of part-region. The two-dimensional pattern formed by the area elements is thus in a regular, irregular or random distribution on the surface of the substrate and may be restricted both to one part-region of the substrate, i.e., for example, located in the centre, or alternatively spread over the entire surface of the substrate.

The two-dimensional pattern formed by the area elements represents a macroscopic pattern, where the individual area elements have a size of at least 0.1 mm², in particular of at least 1 mm², but, depending on the coating technology, may also have sizes of several hundred square centimetres.

The area elements in the solidified state only have a low layer thickness in the range from 0.5 to 10 μm, particular from 1 to 5 μm.

It is essential in accordance with the invention of the surface tension al of the substrate (which may have been pretreated and/or black-, dark- or colour-precoated, but is referred to below as uncoated substrate) in the solid state and the surface tension of the area elements σ2, likewise in the solid state, have different values from one another, expressed in the dimension unit mN/m.

The surface tension of the various part-regions of the substrate provided with the area elements can be determined using any conventional method which is suitable for the determination of surface tensions on solid surfaces, so long as the same method is employed in each case for the determination of the surface tensions, so that the values obtained for the surface tensions σ1 and σ2 are directly comparable with one another. Methods with the aid of which the total surface tension, but also the disperse and polar fraction of the total surface tension can be determined are particularly suitable, where the relationship

σₜₒₜₐₗ=σ_{disperse}+σₚₒₗₐᵣ

applies to each part-area. The Owens, Wendt, Rabel and Kaelbe method, for example, is particularly suitable for this purpose.

It is not particularly important in accordance with the invention whether the part-regions of the substrate that are not coated with the area elements or the part-regions of the substrates that are coated with the area elements have the nominally higher surface tension. It is essential to the invention that there is a measurable difference between the respective total surface tensions σₜₒₜₐₗ of the coated part-regions and the uncoated part-regions of the substrate and that this difference is at least 1 mN/m. The difference between the total surface tensions can be 1 to 20 mN/m, preferably 1 to 10 mN/m and particularly preferably 1 to 5 mN/m.

The total surface tension on the part-regions of the substrate that are coated with the area elements is particularly preferably greater than the total surface tension on the uncoated part-regions of the substrate. In particular, it is preferred if, besides a difference in the total surface tensions, there is also a measurable difference between the respective polar surface tensions σₚₒₗₐᵣ of the coated part-regions and the uncoated part-regions of the substrate. It is particularly preferred here if the difference between the respective polar fractions of the surface tensions σ1ₚₒₗₐᵣ and σ2ₚₒₗₐᵣ is numerically greater than the difference between the respective total surface tensions σ1ₜₒₜₐₗ and σ2ₜₒₜₐₗ, expressed in mN/m. The latter can be set specifically, for example, by adding a surface-active agent which reduces the polar fraction of the total surface tension of the solid surface elements to the coating composition for the coating of the area elements. This addition exerts a significantly lesser influence on the nominal total surface tension obtained after solidification of the area elements than on the polar fraction of the total surface tension of these part-regions.

The difference between the polar surface tensions σ1ₚₒₗₐᵣ and σ2ₚₒₗₐᵣ is in accordance with the invention likewise in the range from 1 to 20 mN/m, but preferably in the range from 5 to 10 mN/m, and is, in particular, greater than the difference between the total surface tensions σ1ₜₒₜₐₗ and σ2ₜₒₜₐₗ.

The liquid or flowable first coating composition which is employed for the application of the area elements to the substrate has, however, in each case a surface tension σ2a which is less than the surface tension σ1 (σ1ₜₒₜₐₗ) of the uncoated substrate in order to achieve a good distribution of the coating composition on the substrate, a sharp delimitation of the area elements to be generated and good adhesion thereof to the substrate. The surface tension σ2a is determined in the same manner as the determination of the surface tension σ3, which is described below.

The substrate employed as basis for the process according to invention thus has on at least one of its surfaces a visible or virtually invisible two-dimensional pattern which consists of part-regions of the surface which are coated with area elements and has boundary lines with uncoated part-areas of the surface of the substrate, where the surface tension σ1 of the uncoated part-areas is different from the surface tension σ2 of the part-areas coated with the area elements.

σ1 and σ2 in each case mean the total surface tensions σ1ₜₒₜₐₗ and σ2ₜₒₜₐₗ.

A coating composition comprising flake-form effect pigments whose surface tension σ3, expressed in mN/m, is less than the surface tensions σ1 and σ2 (σ1ₜₒₜₐₗ and σ2ₜₒₜₐₗ) is now applied to the substrate prepared in this way.

It should be noted here that the surface tension σ3 must be determined with the aid of a different method than the surface tensions σ1 and σ2, since the surface tension σ3 is the value in a flowable coating composition. Various methods are available to the person skilled in the art for the determination of the surface tensions of liquid systems, for example the Du Nouy ring method, the hanging drop method and various others. The surface tensions α3 indicated in accordance with the invention are determined by means of the Du Nouy ring method from the supernatant of the coating composition after the flake-form effect pigments have settled.

The surface tension of the coating composition comprising flake-form effect pigments σ3 is in accordance with the invention also lower than the surface tension σ2a of the first coating composition employed for the production of the area elements, determined with the aid of the same method. The difference in the surface tensions of the coating compositions enables a good distribution of the coating composition comprising flake-form effect pigments and good adhesion thereof both to the part-regions provided with area elements and also to the uncoated part-regions of the substrate.

The difference between the surface tensions of the two coating compositions σ2a and σ3 (σ2a−σ3) is in accordance with the invention in the range from 1 to 12 mN/m, preferably in the range from 3 to 8 mN/m and in particular in the range from 4 to 7 mN/m.

The coating composition comprising flake-form effect pigments, also called effect coating below, comprises at least one binder and at least one type of flake-form effect pigment. The assistants and additives already described above may also be present in the effect coating. Binders which can be employed are likewise the binder systems already mentioned above for the first coating composition, where it should be noted that the surface tension σ3 of the effect coating must be lower than the surface tension σ2a of the first coating composition. The ingredients of the effect coating must therefore be selected in such a way that they meet the conditions according to the invention. The surface tensions of the two coating compositions can easily be determined in preliminary experiments by the methods described above.

In accordance with the invention, both solvent-containing, water-based and also radiation-curing coating systems can be selected for the effect coating. However, preference is given to the use of radiation-curing coatings, in particular UV-curing coatings, since these can be cured very quickly. In particular, coating systems which have relatively low viscosities can advantageously be employed here. UV-curing acrylic coatings, which are commercially available, for example, from Schmid Rhyner AG, Switzerland, under the name WESSCO®, are particularly suitable in accordance with the invention. Of these, coating systems having comparatively low viscosity, for example having a viscosity of <30 sec, determined in accordance with DIN EN ISO 2431 in a 4 mm eflux cup at 23° C., are likewise preferred.

The effect coating additionally also comprises flake-form effect pigments. The specific type of flake-form effect pigment or optionally mixtures of various effect pigments is determined here by the desired optical effects of the resultant pattern having a three-dimensional appearance in the coating and optionally also by colourants which are already present in the area units located on the substrate.

Flake-form effect pigments which can be employed in the coating composition comprising flake-form pigments in accordance with the present invention are pigments which are selected from the group pearlescent pigments, interference pigments, metal-effect pigments, liquid-crystal pigments, flake-form functional pigments, flake-form structured pigments, or a mixture of two or more thereof.

These effect pigments are built up from one or more layers of optionally different materials and are in flake form.

Pigments or support materials are referred to as flake form if their outer shape corresponds to a two-dimensional structure which, with its upper and lower sides, has two two surfaces which are approximately parallel to one another whose length and width dimension represents the greatest dimension of the pigment or support material. The separation between the said surfaces, which represents the thickness of the flake, has, by contrast, a smaller dimension.

These pigments preferably have a flake-form support, which optionally comprises at least one coating of a metal, metal oxide, metal oxide hydrate or mixtures thereof, a metal mixed oxide, suboxide, oxynitride, metal fluoride or a polymer.

Pearlescent pigments consist of transparent flakes of high refractive index and exhibit a characteristic pearlescence due to multiple reflection in the case of parallel alignment. Pearlescent pigments of this type which additionally also exhibit interference colours are known as interference pigments.

Although classical pearlescent pigments, such as TiO₂ flakes, basic lead carbonate, BiOCl pigments or nacreous pigments, are naturally also suitable in principle, the effect pigments employed for the purposes of the invention are preferably flake-form interference pigments or metal-effect pigments, which have at least one coating of a metal, metal oxide, metal oxide hydrate or mixtures thereof, a metal mixed oxide, metal suboxide, metal oxynitride, metal fluoride or a polymer on a flake-form support.

The metal-effect pigments preferably have at least one metal support or a metal layer.

The flake-form support preferably consists of natural or synthetic mica, kaolin or another phyllosilicate, glass, calcium aluminium borosilicate, SiO₂, TiO₂, Al₂O₃, Fe₂O₃, polymer flakes, graphite flakes or of metal flakes, such as, for example, of aluminium, titanium, bronze, silver, copper, gold, steel or diverse metal alloys.

Particular preference is given to flake-form supports of mica, glass, calcium aluminium borosilicate, graphite, SiO₂, Al₂O₃ or of aluminium.

The size of the flake-form support is not crucial per se. The supports generally have a thickness of between 0.01 and 5 μm, in particular between 0.05 and 4.5 μm and particularly preferably from 0.1 to 1 μm. The length or width dimension is usually from 1 to 500 μm, preferably from 1 to 200 μm and in particular from 5 to 125 μm. They generally have an aspect ratio (ratio of mean diameter to mean particle thickness) of from 2:1 to 25,000:1, preferably from 3:1 to 1000:1 and in particular from 6:1 to 250:1.

The said dimensions for the flake-form supports in principle also apply to the coated effect pigments used in accordance with the invention, since the additional coatings are generally in the region of only a few hundred nano-metres and thus do not significantly influence the thickness or length or width (particle size) of the pigments.

A coating applied to the support preferably consists of metals, metal oxides, metal mixed oxides, metal suboxides or metal fluorides and in particular of a colourless or coloured metal oxide selected from TiO₂, titanium suboxides, titanium oxynitrides, Fe₂O₃, Fe₃O₄, SnO₂, Sb₂O₃, SiO₂, Al₂O₃, ZrO₂, B₂O₃, Cr₂O₃, ZnO, CuO, NiO or mixtures thereof.

Coatings of metals are preferably of aluminium, titanium, chromium, nickel, silver, zinc, molybdenum, tantalum, tungsten, palladium, copper, gold, platinum or alloys thereof.

The metal fluoride employed is preferably MgF₂.

Particular preference is given to effect pigments which have a flake-form support of mica, glass, calcium aluminium borosilicate, graphite, SiO₂, Al₂O₃, or of aluminium and at least one coating on the support, selected from TiO₂, titanium suboxides, titanium oxynitrides, Fe₂O₃, Fe₃O₄, SnO₂, Sb₂O₃, SiO₂, Al₂O₃, MgF₂, ZrO₂, B₂O₃, Cr₂O₃, ZnO, CuO, NiO or mixtures thereof.

The effect pigments can have a multilayered structure in which a plurality of layers, which preferably consist of the above-mentioned materials and have different refractive indices such that in each case at least two layers of different refractive index, are located one above the other on the metallic or non-metallic support, where the refractive indices in the individual layers differ by at least 0.1 and preferably by at least 0.3 from one another, are located one above the other on a non-metallic support. The layers located on the support here may be either colourless or coloured, predominantly transparent, semi-transparent or even opaque.

Depending on the support material used and the type of layers applied, the effect pigments obtained are thus also colourless or have a mass tone, or are predominantly transparent, semi-transparent or opaque. Due to the single- or multilayered system on the support, however, they are additionally capable of producing more or less intense and glossy interference colours.

The so-called LCPs (liquid crystal pigments), which consist of crosslinked, oriented, cholesteric liquid crystals, but also polymer or metal flakes known as holographic pigments, may likewise be employed as effect pigments.

The effect pigments described above may be present individually or as a mixture of two or more in the coating compositions employed in accordance with the invention (in the effect coating and optionally also in the first coating composition for the area elements). They may likewise be employed in a mixture with organic and/or inorganic dyes or coloured pigments and/or also in mixtures with uncoated mica. The proportion by weight of the flake-form effect pigments in the respective binder-containing coating composition here is generally between 1 and 20 per cent by weight and preferably between 3 and 15 per cent by weight, based on the total weight of the coating composition.

Effect pigments which can be employed are, for example, the commercially available functional pigments, interference pigments or pearlescent pigments available under the names Iriodin®, Colorstream®, Xirallic®, Miraval®, Ronastar®, Biflair®, Minatec®, Iriotec®, Lustrepak®, Colorcrypt®, Colorcode® and Securalic® or Meoxal® from Merck KGaA, Mearlin® from Mearl, metal-effect pigments from Eckart and optically variable effect pigments, such as, for example, Variochrom®, from BASF, Chromafflair® from Flex Products Inc., Helicone® from Wacker, holographic pigments from Spectratec and other commercially available effect pigments.

The individual colour and/or lustre effects which can be achieved by the effect pigments are not crucial per se for the success of the present invention. Instead, the success according to the invention is achieved by the change in the optically perceptible effect of the flake-form effect pigments at the points of the coating at which the coating composition comprising flake-form effect pigments touches the boundary lines between the area elements forming the two-dimensional pattern on the substrate and the uncoated substrate. At these boundary lines, the flake-form effect pigments in the coating composition, which are otherwise aligned parallel to the surface of the substrate in the coating, are deflected out of their alignment in such a way that they are subsequently at an angle to the surface of the substrate which runs obliquely or perpendicularly to the surface of the substrate. Although the cause of this pigment deflection has not been fully explained, it is thought that the deflection of the pigments out of their usual preferential direction occurs due to the differences in the surface tensions of the area elements and of the uncoated substrate at the boundary lines. The shape of the two-dimensional pattern formed on the substrate by the area elements is consequently replicated as the basic shape of the three-dimensional pattern formed by the effect pigments in the coating composition comprising flake-form effect pigments, combined with a three-dimensional effect generated by the deflection described above of the flake-form effect pigments.

The three-dimensional pattern visible in the coating is thus only perceptible via the optical effects rendered visible by the effect pigments. It is significantly more pronounced here than the real deflection of the flake-form effect pigments at the boundary lines would suggest, since a deflection of the flake-form effect pigments out of the parallel position, even by only a few angle degrees, already has the consequence of a significant change in their reflection properties, which is evident optically as apparent depth of the pattern having a three-dimensional appearance.

However, preference is of course given to the use of effect pigments with which it is possible to achieve optically very attractive print results which cannot to be obtained with classical organic or inorganic dyes or coloured pigments alone. Thus, in particular in packaging printing, intense lustrous interference colours, metallic effects or print images which exhibit a colour play and/or impressive light/dark effects (optically variable prints) on tilting are very desirable. The glitter effect of the print images is often greater here, the larger the particle size of the effect pigments. Such colour and lustre impressions can only be achieved with flake-form effect pigments.

If the flake-form effect pigments employed exhibit an optically variable behaviour, this is of course perceptible in the patterned coating produced in accordance with the invention not only if the viewing angle is changed relative to the entire coated surface, but also on viewing of the surface of the coated substrate from a single viewing angle, so that the three-dimensional pattern generated appears in different colours and/or different brightness grades.

The flake-form effect pigments can also be employed in a mixture with other, non-flake-form pigments, so long as the proportion of flake-form effect pigments is sufficiently large that a three-dimensional pattern generated therewith is still visible in the coating. For this purpose, the proportion of flake-form effect pigments in a coating composition comprising them should correspond to at least 50%, but preferably at least 70% of the total pigment loading of the respective coating composition.

The coating of the substrate with the coating composition comprising flake-form effect pigments can take place over the entire area, which is also preferred owing to the simplicity of the process, at least on the area parts of the substrate which carry the two-dimensional pattern of the area elements. However, it may entirely also be advantageous or desired if the substrate is coated over part of the area with the coating composition comprising flake-form effect pigments. In the case of part-area coating, however, it should be ensured that at least some of the boundary lines which are formed between the part-regions of the substrate which are provided with the area elements and the part-regions of the substrate which are not provided with the area elements are coated with the coating composition comprising flake-form effect pigments, to be precise in such a way that the boundary lines are coated in an overlapping manner and the region of the neighbouring part-region that is adjacent to the boundary lines is thus also coated. This boundary line-overlapping coating is necessary in order to enable the three-dimensional pattern generated by the flake-form effect pigments to become visible in the final coating.

Whether the full-area or part-area coating takes place is dependent on the desired optical effect of the finished product.

The coating composition comprising flake-form effect pigments can be applied to the pretreated substrate using any suitable coating process. Suitable processes are, for example, conventional coating processes, including conventional printing processes which are usually employed for the production of a coating on a substrate. Mention may be made here, in particular, of printing processes such as screen printing, gravure printing, flexographic printing, offset printing, offset overprint varnishing processes, paper-coating processes, bar coating, or intaglio printing processes, but also other coating processes, such as knife coating, brush coating, stamping, pouring, flow processes, roller or screen application processes or application by means of an air brush.

Particular preference is given to the use of printing processes, in particular a flexographic printing process or a gravure printing process. Even in the case of the low layer thicknesses of the solidified coating in the region of a few microns (1-20 μm, preferably 2-10 μm) that are obtainable by means of these processes, the pattern having a three-dimensional appearance generated in accordance with the invention is clearly visible in the coating and optically attractive.

The present invention also relates to a coating comprising flake-form effect pigments and having a pattern having a three-dimensional appearance on a substrate which has been produced by the process described above. Details in relation to the material composition of the substrates which can be employed, the coating composition for the first coating composition forming the area elements, and in relation to the flake-form effect pigments which are suitable in accordance with the invention and the material composition of the coating composition comprising the latter have already been explained in detail above.

As already indicated above, the pattern having a three-dimensional appearance is generated in the coating according to the invention exclusively by the orientation of the flake-form effect pigments present at various angles, relative to the surface of the substrate. The reflection behaviour of the effect pigments, which is modified by the non-parallel alignment of the flake-form effect pigments at the boundary lines of the area elements, considerably reinforces the optically perceptible three-dimensional effect. Neither the substrate nor the coating that is applied thereto are three-dimensionally deformed here. In particular, the coating has a planar surface.

The pattern having a three-dimensional appearance which is present in accordance with the invention in the coating represents a macroscopic pattern, where the individual area elements visible in the coating have a size of at least 0.1 mm², in particular of at least 1 mm², but may also have sizes of several hundred square centimetres. The size and outer shape of the visible area elements having a three-dimensional appearance is directly dependent on the size and outer shape of the two-dimensional area elements formed on the substrate.

The present invention also relates to the use of a coating comprising flake-form effect pigments on a substrate which has a pattern having a three-dimensional appearance and has been produced by the process described above.

Since the process described above, in particular if printing processes are employed for the application of the coating compositions, is particularly suitable for the production of mass-produced products, the use of the coatings generated in this way in decorative materials, packaging materials, works of art or security products is of particular economic advantage.

Decorative materials are intended to be taken to mean all applications which are distinguished by particular optical effects, for example job printed materials, calendars, illustrated sheets, advertising materials, greetings cards, offprints, wallpapers, decorative papers for furniture and flooring laminates and many more. Such products can experience a great increase in value due to the attractive effect having a three-dimensional appearance generated by means of the process according to invention, since they simultaneously also exhibit the lustre and glitter effects and the optionally also optically variable properties of the flake-form effect pigments employed.

The same applies to all types of packaging materials and to security products, which, besides functional features, are also intended to exhibit optically readily perceptible effects of high attractiveness.

Since the coatings having a pattern having a three-dimensional appearance which are produced in accordance with the invention may also generate optical illusions, they can also advantageously be employed for the production of works of art.

Overall, the coatings having a pattern having a three-dimensional appearance which are produced in accordance with the invention have an apparent optical depth of the visible three-dimensional pattern and the optical advantages of coatings comprising flake-form effect pigments. Neither the substrates employed nor the coatings have to undergo embossing for this purpose. In addition, the precoated and thus pre-patterned substrates can also be stored in a roll form and transported over relatively long distances, which leads to high flexibility at production sites and possible application processes. The coatings according to invention are therefore highly suitable for the production of products of a wide variety of types having a high-value appearance with the aid of simple and conventional process steps inexpensively and as mass-produced products.

The present invention is intended to be explained in greater detail below with reference to examples, but not reduced thereto.

### EXAMPLES

### Example 1

A paper of the Sappi AlgroFiness type having a base weight of 70 g/m² which is coated on one side and is additionally provided on the coated side with a black primer layer over the entire area is employed. The substrate treated in this way has a total surface tension σₜₒₜₐₗ of 41.9 mN/m, which is composed of a disperse surface tension σ_{disperse} of 34.6 mN/m and a polar surface tension σₚₒₗₐᵣ of 7.3 mN/m.

The substrate is coated with a first coating composition, so that a pattern of coated and uncoated part-areas arises on the substrate. The coating is carried out in a gravure printing process using a gravure printing cylinder having a line account of 70 L/cm, MSGI, 45 μm in full tone. The first coating composition comprises the water-based coating Galacryl® 82.431.01 from Schmid Rhyner AG comprising 8% by weight, based on the coating composition, of a surface-active additive and no further ingredients. The pattern generated in this way on the surface of the substrate is virtually invisible.

The surface tension of the liquid coating composition for the first coating composition, determined by the Du Nuoy ring method, is 26.7 mN/m. After solidification of the area elements by drying, the area elements have a total surface tension σₜₒₜₐₗ of 43.4 mN/m, which is composed of a disperse surface tension σ_{disperse} of 42.4 mN/m and a polar surface tension σₚₒₗₐᵣ of 1.0 mN/m.

A second coating composition is now applied to the substrate pre-patterned in this way (gravure printing process, gravure printing cylinder having a line count of 70 L/cm MSGI 45 μm full area, printing speed 10 m/min, 30 m/min, 40 m/min) and solidified by means of UV light. The second coating composition comprises the UV coating Wessco 37.380.02 from Schmid Rhyner AG and 5% by weight, based on the coating composition, of an interference pigment of the Iriodin® 325 type from Merck KGaA, Germany. The surface tension of the supernatant of the liquid coating composition, determined by the Du Nuoy ring method, is 20.8 mN/m. The coating composition has a viscosity of 20 sec., measured in a DIN 4 mm eflux cup.

At a printing speed of 10 and 30 m/min, clear patterns having a three-dimensional appearance which are formed by the effect pigments present and have the two-dimensional basic design of the area elements preprinted with the primer can be seen in the final coating solidified by UV light. The coated surface is smooth and has no deformations. The coating is characterised by high lustre and an optically attractive appearance. At a printing speed of 40 m/min, a pattern having a three-dimensional appearance can likewise be perceived in the coating, but this is less pronounced than in coatings obtained at printing speeds of 10 and 30 m/min.

1. Process for the production of a pattern having a three-dimensional appearance in a coating comprising effect pigments on a substrate, where a surface of a substrate which is provided in part-regions with area elements which represent a two-dimensional pattern is coated with a coating composition comprising flake-form effect pigments and this coating composition is solidified, where the part-regions of the substrate which are provided with the area elements and part-regions of the substrate which are not provided with the area elements have surface tensions σ1 and σ2 which are different from one another, and where the coating composition comprising flake-form effect pigments has a surface tension σ3 which is lower than the surface tensions σ1 and σ2.

2. Process according to claim 1, characterised in that the area elements consist of a solidified first coating composition.

3. Process according to claim 2, characterised in that the first coating composition comprises no pigments.

4. Process according to claim 2, characterised in that the first coating composition comprises dyes, absorption pigments and/or effect pigments.

5. Process according to claim 1, characterised in that a black, dark or coloured substrate is employed.

6. Process according to claim 1, characterised in that the area elements are generated by the application and solidification of a first coating composition which has a surface tension σ2a which is lower than the surface tension of the substrate σ1 and greater than the surface tension σ3 of the coating composition comprising flake-form effect pigments.

7. Process according to claim 6, characterised in that the difference between the surface tension of the first coating composition σ2a and the surface tension of the coating composition comprising flake-form effect pigments σ3 is in the range from 1 to 12 mN/m.

8. Process according to claim 7, characterised in that the difference is in the range from 3 to 8 mN/m.

9. Process according to claim 1, characterised in that the substrate is coated over the entire area with the coating composition comprising flake-form effect pigments.

10. Process according to claim 1, characterised in that the substrate is coated over part of the area with the coating composition comprising flake-form effect pigments, where boundary lines which are formed between the part-regions which are provided with the area elements and the part-regions which are not provided with the area elements are coated at least partly with the coating composition comprising flake-form effect pigments.

11. Process according to claim 1, characterised in that the coating composition comprising flake-form effect pigments is applied to the substrate by means of a printing process.

12. Process according to claim 1, characterised in that the substrate is a paper, cardboard, wallpaper, laminate, tissue material, wood, plastic body, plastic film, metal body, metal foil, glass or a material which contains constituents from a plurality of these substances, and where the substrate has optionally been precoated.

13. Process according to claim 1, characterised in that the flake-form effect pigments are selected from the group pearlescent pigments, interference pigments, metal-effect pigments, liquid-crystal pigments, flake-form functional pigments, flake-form structured pigments, or mixtures comprising these.

14. Process according to claim 1, characterised in that the pattern having a three-dimensional appearance in the coating has a two-dimensional basic shape which corresponds to the shape of the two-dimensional pattern which is formed from the area elements on the substrate and is coated with the coating comprising flake-form effect pigments.

15. Coating comprising flake-form effect pigments on a substrate which has a visible pattern having a three-dimensional appearance, produced by a process according to claim 1.

16. Coating comprising flake-form effect pigments according to claim 15, where the pattern having a three-dimensional appearance is a macroscopic pattern and has area elements having a size of at least 0.1 mm².

17. Coating comprising flake-form effect pigments according to claim 15, where the pattern having a three-dimensional appearance is formed by orientation of the flake-form effect pigments in the coating at various angles, relative to the substrate.

18. Coating comprising flake-form effect pigments according to claim 15, characterised in that the coating has a planar outer surface.

19. A method which comprises including a coating comprising flake-form effect pigments according to claim 15 in decorative materials, packaging materials, works of art or security products.

20. Decorative materials, packaging materials, works of art or security products comprising a coating comprising flake-form effect pigments according to claim 15.
